(19) United States
(12) Patent Application Publication
(10) Pub. No.: US 2017/0030502 A1
(43) Pub. Date: Feb. 2, 2017

(54) PIPE JOINT CONNECTION SYSTEM

(71) Applicant: Hydra-Ring Limited, Bolton, Lancashire (GB)

(72) Inventor: Philip HARRISON, Bolton (GB)

(21) Appl. No.: 15/303,394

(22) PCT Filed: Apr. 10, 2015
(86) PCT No.: PCT/GB2015/051106

§ 371 Date: Oct. 11, 2016

(30) Foreign Application Priority Data
Apr. 11, 2014 (GB) 1406534.6
Nov. 5, 2014 (GB) 1419685.1

(51) Int. Cl. F16L 37/14; F16C 19/36; F16C 33/50; F16C 33/38

(52) U.S. Cl. CPC F16L 37/148; F16C 33/3825; F16C 19/362; F16C 33/506

(57) ABSTRACT

Pipe joint connector (10) comprising a flexible elongate portion (12), wherein the flexible elongate portion is provided with a plurality of rotatable members (14).

### FIELD OF THE INVENTION

This invention relates to an improved pipe joint connector, especially for use with high pressure hoses and pipes.

### BACKGROUND TO THE INVENTION

A problem with existing pipe joint technology is that it often requires torqueing and welding to be undertaken to ensure a reliable joint. Where pipe lines fail, most of the time it is down to a failure in pipe joints and this is usually attributed to the welding and torqueing of the joint. This may be a result of different torqueing levels and poor welding quality. Additionally, with welding a joint, non-destructive testing needs to be undertaken to ensure the integrity of the joint, which is both costly and time-consuming.

Another proposed system uses flexible wound metal wire to connect pipes from the exterior using an internal groove on the pipe. However, such systems use force and/or lubricant to insert the connector, which can lead to damage during the process of inserting and removing the connector, resulting in unpredictable failure. Additionally, the system is messy and costly, and removal of the connector can be difficult.

Further systems utilising similar technology include rotary, or swivel, joints. Whilst these are effective at high pressures, they are difficult and time-consuming to disassemble in order to clean or maintain. Preassembled bearings within the above are joined to hoses and tubes by threads which require torqueing as specified.

### SUMMARY OF THE INVENTION

Accordingly, the invention is directed to a pipe joint connector comprising a flexible elongate portion, wherein the flexible elongate portion is provided with a plurality of rotatable members.

In one arrangement, the present invention is directed to a pipe joint connector comprising a flexible elongate portion, or member, wherein the flexible elongate portion is provided with a plurality of rotatable members. The use of rotatable members allow the connector to effectively ‘roll’ into a pipe joint aperture, thereby reducing stress and the need for lubricants. Furthermore, the use of a connector and system in accordance with the present invention reduces component costs, labour costs and further costs associated with testing, cleaning and maintenance

Advantageously, the rotatable members comprise a ball bearing or a roller. Ball bearings have been used in various pipe joint applications and have been shown to provide effective strength and good resistance against the pressures experienced by high pressure pipe systems. By encapsulating them and allowing them to rotate within the connector allows the resistance and qualities of ball bearings acts as a quick connect/release mechanism. Additionally, ball bearings have multi-axis rotation, thereby allowing them to easily pass through apertures and channels to easily connect pipes and/or hoses. Rollers, which are arranged to have an axis of rotation perpendicular with a channel into which they are fed, may be of a cylindrical construction and thus not only rotate to allow quick insertion and withdrawal, but have flattened surfaces to engage the pipes and spread the pressure experienced over a larger area, if deemed necessary.

Preferably, at least some of the rotatable members comprise a material selected from a group comprising: stainless steel; carbon-chrome steel; tungsten carbide nickel; and ceramic material. Other hardened or high strength material may be used. The rotatable members may provide a point contact rather than making full contact with the groove surface. Therefore, it is preferable to use particularly hard materials to resist the pressures within the pipe joint.

It is advantageous that the elongate portion is moulded and then the rotatable members are inserted therein. By moulding the elongate portion and then inserting the rotatable members, the rotatable members are contained within the elongate portion itself and the rotatable members can be securely fastened there, either by the use of a further part or by the resilience of the plastics material. The apertures in the elongate portion are sized to retain the individual rotatable members, thereby reducing the risk of incorrect tolerances.

In one construction, the connector is provided with a locking head section at one end. By providing a locking head section at the end of the connector allows for it to be connected to the join mechanism and retained in place, thereby reducing the risk of inadvertent disconnection. The locking head connector may be formed integrally with the flexible material, which reduces the cost of production and allows for quicker manufacturing times.

In a preferable embodiment, the locking head connector comprises a screw-thread and in a more preferable embodiment, the locking head connector is rotatable relative to the flexible elongate portion. The screw-thread, which may be independently rotatable relative to the rest of the device, may be external so that it can be screwed into the joint to which it is fed. Alternatively, it may be internal to part of the head so that the head may be screwed onto an external threaded part of the joint.

It is advantageous that the flexible elongate portion and/or the head connector comprises plastics material. Using plastics material to retain the rotatable members allows the rotatable members to be effectively retained within the elongate portion and allows for readily quick production. Additionally, the use of plastics materials provides for good flexibility and at the same time is sufficiently strong to withstand the forces required to insert and remove the connector. Furthermore, the locking head connector and the flexible portion can be made as an integral, one-piece, part, which can be made in many variable colours easing identification over mechanically produced steel connectors.

It is particularly useful that at least part of the elongate portion has a transverse cross-section comprising a circle bisected by a rectangle. The use of a transverse cross-section comprising a larger middle portion with sideways extensions, for example a circle bisected by a rectangle, allows for the middle portion to prevent the joint from becoming disengaged, whilst the side extensions prevent rotation of the connector when inserted into the pipe connector channel. Whilst other shapes may be possible, the circular nature allows the rotatable members to contact the channel and rotate upon insertion and retraction of the connector.

In a further arrangement, the invention is directed to a pipe joint connector comprising a flexible elongate portion, wherein a plurality of rotatable members are held partially within the flexible elongate portion and protrude therefrom, and wherein a first group of the rotatable members is arranged to allow rotation about a first axis and a second group of the rotatable members is arranged to allow rotation about a second axis.

By arranging the rotatable members in a plurality of groups, with each group having a different axis of rotation, the connector can be adapted to allow for a smoother flow through the pipe joint. This is because the first group of rotatable members can contact a first surface within the pipe joint aperture, and the second group can contact another surface. Therefore, the connector passes smoothly over two surfaces of the aperture, thereby creating a connector that more easily passes into and out of the connection joint.

It is preferable that at least one of the first axis and the second axis that is non-parallel with the longitudinal axis of the flexible elongate portion. The use of non-parallel axes allows the rotatable members to contact the surface of the pipe joint and roll thereover, which reduces the friction between the connector and the pipe joint. An axis of rotation parallel with the longitudinal axis of the connector only allows the rotatable members to rotate laterally with respect to the elongate member, which is against the direction of movement into the pipe joint. Therefore, non-parallel axes of rotation are preferred.

Advantageously, the plurality of rotatable members is arranged such that the axis of the rollers alternates between the first group and second group and, of particular advantage is having the axis of the first group arranged orthogonally to the axis of the second group. In such an arrangement, alternate rotatable members rotate along different axes and an angle between them can be created. Where rollers are used, this allows adjacent rollers to have a 90° angle between their top edges, which, in turn, can be used in a square or rectangular pipe joint groove. The angle may be adjusted such that it is not orthogonal, where required. Although and obtuse or acute angle may be less advantageous in many applications, it may provide an advantage in some arrangements.

Where two axes of rotation are used for the rotatable members, the first axis and the second axis may be substantially perpendicular to the longitudinal axis of the elongate member. This allows the rotatable members to rotate longitudinally with respect to the elongate member and so provide allow the connector to ‘roll’ into and out of the pipe joint.

The rotatable members may comprise cylindrical rollers. Where rollers are used, the forces in pressurised conduits are spread over a larger contact area, thereby reducing the risk of Brinelling.

The invention extends to a pipe joint connector comprising a flexible elongate portion, wherein at least part of the elongate portion has a transverse cross-section comprising a circle bisected by a rectangle. In such a connector, it is preferable that the connector comprises a locking head section and it is particularly advantageous that the locking head section is rotatable relative to the elongate portion. The connector may comprise plastics material.

The invention further extends to a conduit comprising an internal groove and an aperture to allow communication between the external surface of the conduit and the groove such that a connector can be threaded through from the outside of the collar into the groove.

In one construction, the conduit comprises a second internal groove and associated aperture such that it can receive and connect to two further conduits. This creates a collar or a female-female attachment into which two male conduits may be secured using a connector as described herein.

It is advantageous, that the profile of the, or each, aperture comprises a circle bisected by a rectangle or a rectangle/square, particularly one with T-shaped protrusions at one or more corners. This provides a secure locking mechanism with predicative modes of failure for maintenance

### BRIEF DESCRIPTION OF THE DRAWINGS

An embodiment of the invention will now be described, by way of example only, and with reference to the accompanying drawings, in which:

FIG. 1 is a diagram showing a first pipe connector in accordance with the present invention;

FIG. 2 is a cross-sectional diagram showing of a second pipe connector and tool in accordance with the present invention;

FIG. 3 is a diagram showing the pipe connector of FIG. 2 in a second position;

FIG. 4 is a cross-sectional diagram showing a pipe in accordance with the present invention;

FIG. 5 is a cross-sectional diagram showing the pipe of FIG. 4 in combination with a connector;

FIG. 6 is a diagram showing a pipe arrangement in accordance with the present invention;

FIG. 7 is a perspective view of a connector system in accordance with the present invention;

FIG. 8 is a second view of the system of FIG. 7;

FIG. 9 is a third view of the system of FIG. 7.

FIG. 10 is a view of a second embodiment of a connector in accordance with the present invention;

FIG. 11 is a drawing of a pipe for use with the connector of FIG. 10;

FIG. 12 is an enlarged view of the profile of the pipe joint of FIG. 11; and

FIG. 13 is a view of the aperture for accepting the connector of FIG. 10.

### DETAILED DESCRIPTION OF EXEMPLARY EMBODIMENTS

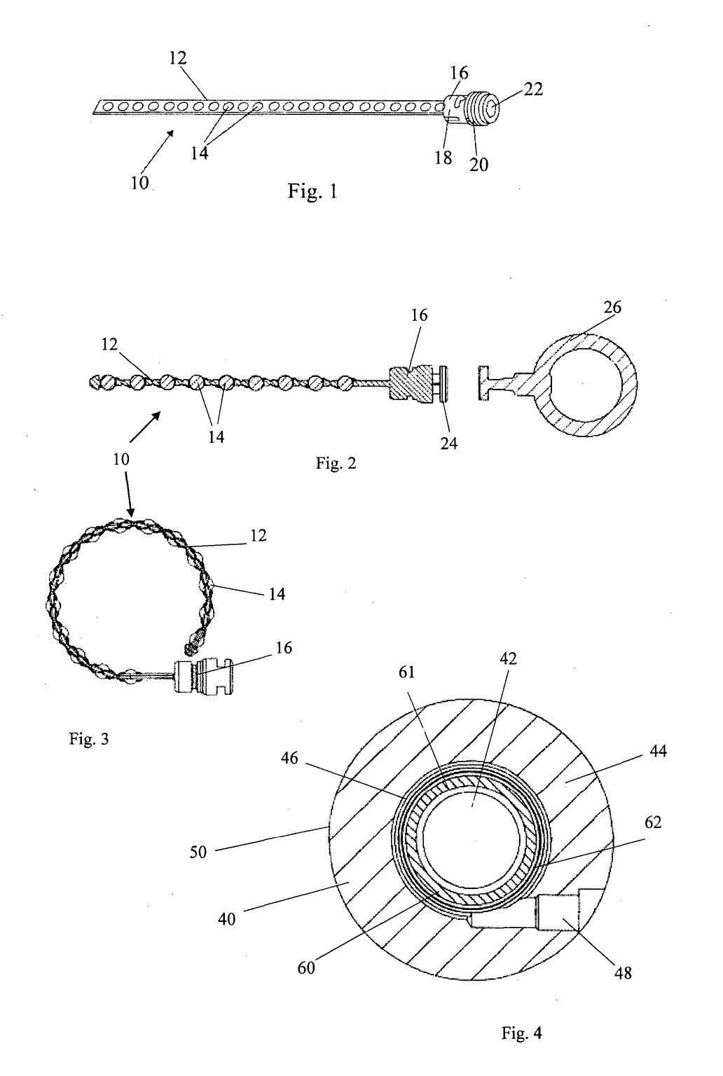

FIG. 1 shows a connector 10 comprising a flexible elongate portion 12, in which are contained rotatable members 14, in the form of metallic ball bearings. The end of the flexible elongate portion 12 is provided with a head section 16. The head section 16 comprises a connector 18 and an externally threaded fastening part 20. The fastening part 20 is rotatable relative to the elongate portion 12 and is provided with a hex-key recess 22 for accepting a hex-key to allow the fastening part 20 to be rotated.

The flexible elongate portion 12 comprises a plastics material, into which rotatable members are positioned, at the same time allowing the rotatable members to rotate freely.

FIGS. 2 and 3 show a second embodiment of a connector 10. Again, the connector 10 comprises a flexible elongate portion 12 in which rotatable members 14, in the form of ball bearings, are retained. The locking head section 16 of this embodiment, which is independently rotatable relative to the elongate flexible portion 12, comprises a shaped portion 24 and a tool 26 having a complementary receiving section. The shaped portion 24 can be engaged by the tool 26 and the shaped portion may be pulled or pushed using the tool 24, thereby moving the connector 10.

FIG. 3 shows how the flexible portion 12 may be deformed into a substantially circular shape.

FIG. 4 shows a cross-sectional view of a pipe joint comprising a first conduit 40, which may be a pipe, tube or hose, comprising a central aperture 42 surrounded by a wall 44. The internal surface of the wall 44 is provided with a groove 46 with a profile to match the upper surface of the connector of FIG. 2. The groove 46 is substantially transverse to, or lateral of, the axis of the conduit 40. The first conduit 40 is further provided with a connection aperture 48 to allow communication between the internal groove 46 and the external surface 50.

A second conduit 60 with an external surface of its wall 61 having a smaller diameter than the aperture 42 of the first conduit, is coaxially inserted into the first conduit 40 such that its aperture 42a is aligned with the aperture 42 of the first conduit 40. The second conduit 60 is provided with an external groove 62, which is shaped to match the profile of the lower surface of the connection of FIG. 2.

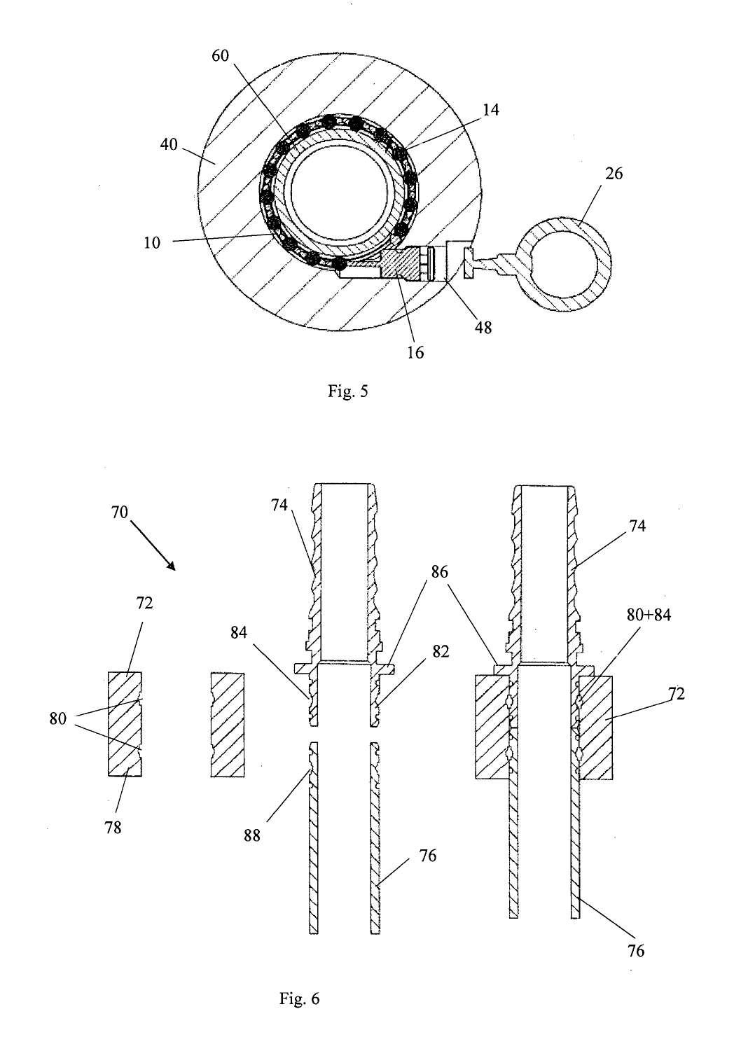

As shown in FIG. 5, when the second conduit 60 has been positioned within the first conduit 40, the connector 10 is inserted into the connection aperture 48. The connector 10 enters the corresponding grooves 46 and 62 and as the grooves arc round the flexible portion 12 adjusts accordingly. Additionally, the rotatable members 14 rotate as they contact the surfaces of the grooves 46 and 62 to allow the connector 10 to be easily inserted into the connection aperture 48.

Once the connector 10 has been fully inserted into the connection aperture 48, the grooves 46 and 62 accept at least a quarter of each of the rotatable members 14. With each rotatable member 14 being partially contained within each groove 46 and 62, the two conduits 40 and 60 become locked together and cannot be disconnected. The locking head 16 is pushed into the connection aperture 48 such that it no longer extends outside the external surface 50 of the first conduit 40. Retaining means in the form of a screw thread may be positioned within the connection aperture to engage the locking head 16 and reduce the risk of inadvertent removal. Tool 26 may be used to engage the head section 16 to insert and/or remove the connector 10.

FIG. 6 shows a cross sectional view of a pipe assembly 70 comprising a collar 72, a first pipe 74 and a second pipe 76.

The collar 72 comprises a wall 78 and two internal grooves 80. The first pipe 74 comprises a connection end 82 having an external groove 84 comprising and a flange section 86 adjacent the connection end 82. The second pipe 76 comprises an external groove 88 at one end. Additionally, the first pipe 74 and the 76 second pipe are provided with O-ring grooves 90 either side of the grooves 84 and 88 for accepting O-rings in order to improve the connection and reduce the risk of leakage. The grooves 80, 84 and 88 are shaped with an arcuate top and bottom section connecting two rectangular sections each side, thereby reflecting a circle bisected by a rectangle.

First pipe 74 is inserted into the collar 72 until the flange section 86 contacts the end of the collar 72. Once the flange 86 is in contact with the collar 72, the first pipe 74 has been inserted to the correct length and the second pip 76 is inserted into the collar 72 until its front end contacts the first pipe 74. When the two pipes 74 and 76 are both inserted into the collar 72, the external grooves 84 and 88 of the pipes 74 and 76 align with the internal grooves 80 of the collar 72. The alignment allows for a connector to be inserted through the collar 72 and into the aligned grooves 80, 84 and 88 to lock the pipes 74 and 76 in the collar 72. The collar 72 provides a female-female connection for two ‘male’ pipes 74 and 76.

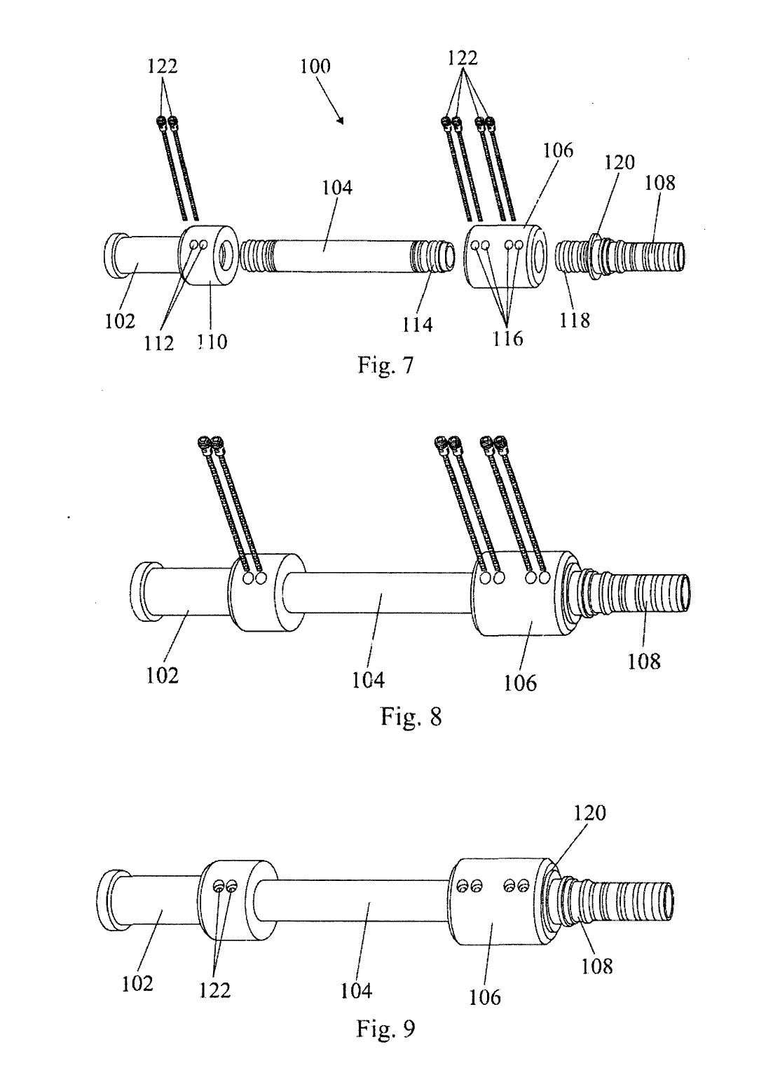

FIGS. 7 to 9 show a perspective view of a system 100 comprising a first pipe 102, a second pipe 104, a collar 106 and a third pipe 108. First pipe 102 is provided with a female connection 110 at its end, which is provided with two connection apertures 112 and associated internal grooves. The second pipe 104 is provided with two male connections 114 at each of its ends, which comprise external grooves. The connector 106 is a female-female connector (similar to that shown in FIG. 6), which is provided with two connection apertures 116 at each end. Third pipe 108 comprises a male connection groove section 118 having two external grooves and a flange 120 (similar to pipe 74 in FIG. 6). The system 100 further comprises connectors 122 with one for each connection aperture 112 and 116, with each connector 122 comprising a rotatable member within an elongate flexible member and having a profile that matched the profile of the groove.

The pipes 102, 104 and 108 and collar 106 are positioned together and the external grooves 114 and 118 on the male sections are aligned with the internal grooves on the female sections.

The connectors 122 are then fed into the connection apertures 112 and 116 to secure the arrangement 100 together. To disconnect the arrangement 100, the connectors 122 are simply withdrawn from the apertures 112 and 116 and the rotatable members roll through the grooves so enable quick and easy removal. The parts 102, 104, 106 and 108 can then be disengaged.

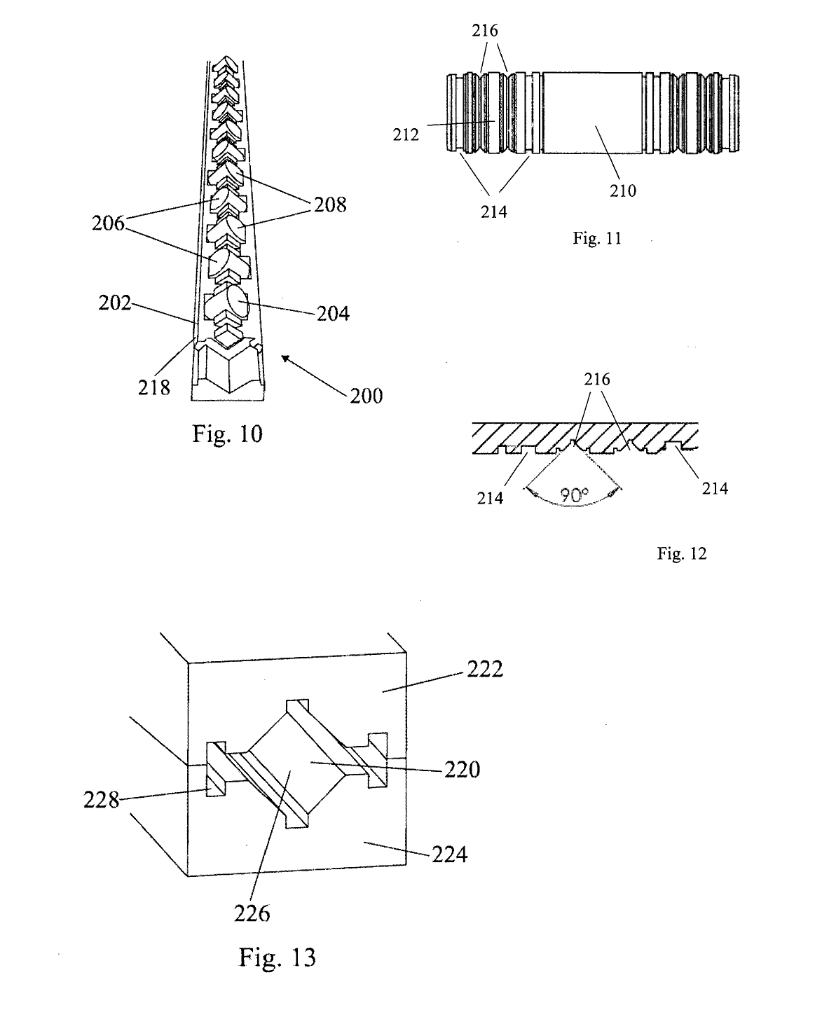

FIG. 10 shows a connector 200 comprising an elongate portion 202 formed of injection moulded plastics material, and a plurality of cylindrical rollers 204 retained within the elongate portion 202 and protruding therefrom. The rollers 204, and the axes thereof, extend transversely across the elongate portion 202. The rollers 204 are arranged so that a first group 206 has a first axis that extends laterally across the elongate portion 202 and at an upward angle of 45° from the surface of the elongate portion 202 in a first direction. The second group of rollers 208 extend at the same upward angle but in the opposite lateral direction, thereby meeting above and at the centre of the elongate portion 202.

The top edges of the rollers in the first group 206 and the second group 208 are aligned to form an apex centrally along the connector, with their axes being orthogonal to one another. The rollers 204 are arranged to alternate between groups along the length of the elongate portion 202 so that a roller from the first group 206 is adjacent a roller of the second group 208, which is followed by another of the first group 206 and so on. When viewed from one end, the connector 200 may be considered to form prism above the elongate portion 202.

FIGS. 11 to 13 show a pipe 210 having a male joint section 212 for connecting it to a corresponding female pipe (not shown). The profile of the male joint section 212 and the female joint section comprises O-ring grooves 214 for receiving O-ring seals each side of connector grooves 216. As seen in the enlarged view in FIG. 12, the connector grooves 216 comprise a 90° angle, thereby creating a triangular groove, which is sized to accept the connector 200 and hold the parts together using the cylinders 204 to lock the connected pipe and prevent them from disconnecting.

To reduce the risk of the connector 200 from twisting as it is being inserted to removed, it is provided with T-shaped flanges 218 extending laterally from the sides of the elongate portion 202. The flanges 218 help to guide the connector 200 into the pipe joint aperture 220, the aperture being more clearly shown in FIG. 13. The aperture 220 is formed by complementary parts being positioned appropriately with one half of the aperture being formed by a first pipe 222 and the other half being formed by a second pipe 224. The aperture 220 comprises a central rectangular region 226, which in the embodiment in the figures is square, and T-shaped flanges 228 extending laterally therefrom. When the connector 200 is inserted, the two parts 226 and 228 cannot be disengaged because the rollers 204 extend into each pipe 226 and 288 and prevent axial movement relative to one another.

The rotatable members may comprise carbon-chrome steel, stainless steel or other types of metal, including tungsten carbide nickel. Other hardened materials may also be used, including harden plastics material or ceramic materials.

Where a particular type of connection is described, it will be appreciated that a different type of connection may be used. For example: a bayonet fitting may be preferable to a screw-threaded fitting; and a hex-key fitting may be substituted with a bayonet fitting or other type of socket and tool system.

Where single or double groove connections have been shown, it may be preferable to use a different number of connections depending on the situation and the associated pressures on the conduits/joints.

The invention may comprise a plurality of rollers with axes substantially perpendicular to the length of the flexible elongate portion. The rollers are then able to assist with the rolling of the connector into the conduits in the pipe. Additionally, the flat sides of the rollers spread the load then the pipes or hoses are under pressure and provide a larger contact surface area compared to a point contact provided by ball bearings. This results in a reduced risk of Brinelling.

Features of one embodiment of the present invention may be incorporated into one of the other embodiments

1. A pipe joint connector comprising a flexible elongate portion, wherein the flexible elongate portion is provided with a plurality of rotatable members.

2. A pipe joint connector according to claim 1, wherein the plurality of rotatable members are held partially within the flexible elongate portion and protrude therefrom.

3. A pipe joint connector according to claim 1, wherein the rotatable members are arranged to allow rotation about an axis that is non-parallel with the longitudinal axis of the flexible elongate portion.

4. A pipe joint connector according to claim 1, wherein a first group of the rotatable members is arranged to allow rotation about a first axis and a second group of the rotatable members is arranged to allow rotation about a second axis.

5. A pipe joint connector according to claim 4, wherein at least one of the first axis and the second axis is non-parallel with the longitudinal axis of the flexible elongate portion.

6. A pipe joint connector according to claim 4, wherein the plurality of rotatable members is arranged such that the axis of the rotatable members alternates between the first group and second group.

7. A pipe joint connector according to claim 5, wherein the axis of the first group is orthogonal to the axis of the second group.

8. A pipe joint connector according to claim 4, wherein the first axis and the second axis are substantially perpendicular to the longitudinal axis of the elongate member.

9. A pipe joint connector according to claim 1, wherein the rotatable members comprise a ball bearing or a roller.

10. A pipe joint connector according to claim 1, wherein at least some of the rotatable members comprise a material selected from a group comprising: stainless steel; carbon-chrome steel; tungsten carbide nickel;
and ceramic material.

11. A pipe joint connector according to claim 1, wherein the elongate portion is moulded and the rotatable members are subsequently inserted into recesses therein.

12. A pipe joint connector according to claim 1, wherein the connector is provided with a locking head section at one end.

13. A pipe joint connector according to claim 12, wherein the locking head connector comprises a screw-thread.

14. A pipe joint connector according to claim 12, wherein the locking head connector is rotatable relative to the flexible elongate portion.

15. A pipe joint connector wherein the flexible elongate portion and/or the head connector comprises plastics material.

16. A pipe joint connector according to claim 1, wherein at least part of the elongate portion has a transverse cross-section comprising a circle bisected by a rectangle.

17. A pipe joint connector according to claim 1, wherein at least part of the elongate portion has a transverse cross-section comprising a square with T-shape profiles at each corner.

18. A pipe joint connection system comprising:
a first conduit having an internal groove and an aperture to allow communication between the external surface of the conduit and the groove such
that a connector can be threaded through from the outside of the collar into the groove;
a second conduit having an external groove, the second conduit having an external diameter less than that of the first such that it can be inserted into the first to align the external groove of the second conduit and the internal groove of the first conduit; and
a connector according to claim 16,
wherein the profile of the aperture of the first conduit and of the channel formed by the grooves of the first and second conduits when aligned comprises a circle bisected by a rectangle.

19. A pipe joint connection system comprising:
a first conduit having an internal groove and an aperture to allow communication between the external surface of the conduit and the groove such that a connector can be threaded through from the outside of the collar into the groove;
a second conduit having an external groove, the second conduit having an external diameter less than that of the first such that it can be inserted into the first to align the external groove of the second conduit and the internal groove of the first conduit; and
a connector according to claim 17,
wherein the profile of the channel formed by the grooves of the first and second conduits when aligned comprise a square with T-shape profiles at each corner.
